(19) United States
(12) Patent Application Publication
(10) Pub. No.: US 2024/0173802 A1
(43) Pub. Date: May 30, 2024

(54) LASER PROCESSING MACHINE AND LASER PROCESSING METHOD

(71) Applicant: AMADA CO., LTD., Kanagawa (JP)

(72) Inventor: Akihiko SUGIYAMA, Kanagawa (JP)

(73) Assignee: AMADA CO., LTD., Kanagawa (JP)

(21) Appl. No.: 18/283,421

(22) PCT Filed: Mar. 22, 2022
(86) PCT No.: PCT/JP2022/013107

§ 371 Date: Sep. 21, 2023

(30) Foreign Application Priority Data
Mar. 26, 2021 (JP) 2021-053945

(51) Int. Cl. B23K 26/359; B23K 26/08; B23K 26/14; B23K 101/18

(52) U.S. Cl. CPC B23K 26/359; B23K 26/08; B23K 26/1462; B23K 2101/18

(57) ABSTRACT

A laser processing machine includes: a processing head that emits a laser beam from an opening; carriages that move the position of the processing head; a Galvano scanner unit that vibrates the laser beam emitted from the opening to vibrate the beam spot on the surface of the sheet metal; and a numerical control (NC) device. The NC device marks a marking-off line on the sheet metal by reading a processing program for marking the marking-off line on the surface of the sheet metal and information on the vibration range of the laser beam corresponding to a set thickness of the marking-off line, and controlling the carriages to advance the irradiation position of the laser beam in a predetermined direction while controlling the Galvano scanner unit to vibrate the beam spot on the surface of the sheet metal at the read vibration range.

### TECHNICAL FIELD

The present invention relates to a laser processing machine and a laser processing method.

### BACKGROUND ART

To ensure accurate laser processing on a sheet metal (workpiece), a marking-off line indicating a processing position is marked in advance on the surface of the workpiece to be processed.

Marking for forming a marking-off line on the surface of the workpiece is performed by irradiating the surface of the workpiece with a laser beam from a laser processing machine. The laser beam from the laser processing machine with which the surface of the workpiece is irradiated generally has a beam intensity distribution in a Gaussian shape, and marking is performed in a state where the focal point of the laser beam is aligned with the surface of the workpiece (just-focused state). Thus, only a high beam intensity portion of the laser beam with which the workpiece surface is irradiated is absorbed by the workpiece surface, and a fine linear marking-off line is marked.

### CITATION LIST

### Patent Literature

Patent Literature 1: Japanese Patent No. 2593464

### SUMMARY

Depending on the content of the workpiece processing, it may be desired to perform marking on the surface of the workpiece and draw a wide, thick marking-off line before processing. In such a case, a thick marking-off line is marked by repeatedly drawing such a thin, linear marking-off line as described above, while slightly shifting the line to fill in the thick marking-off line. However, there has been a problem with repeated drawing of a thin marking-off line in requiring significant time and labor. There has also been a problem with repeated irradiation on the surface of the workpiece with the laser beam in leading to discoloration due to the effect of oxidation or the like.

Another possible method for marking a thick marking-off line is to increase the thickness of the laser beam with which the surface of the workpiece is irradiated by moving the processing head of the laser processing machine away from the workpiece before irradiation, that is, by moving the focal point of the laser beam away from the surface of the workpiece to bring the workpiece into a defocused state. However, irradiation with the laser beam in this manner causes a reduction in energy density. To compensate for this, if the output of the laser beam is increased to such an extent that the laser beam is absorbed by the workpiece surface, the beam intensity of the reflected light also increases in relation to the absorptance (or reflectivity) of the laser beam. This requires additional safety considerations and makes it difficult to draw a thick marking-off line, which has been problematic.

A laser processing machine according to one aspect of the present invention includes: a processing head having a nozzle attached to a tip end of the machine head, the nozzle being configured to emit a laser beam from an opening; a converging lens provided in the processing head and configured to converge the laser beam to form a beam spot on a surface of a sheet metal; a moving mechanism configured to move a relative position of the processing head with respect to the surface of the sheet metal; a beam vibration mechanism configured to vibrate, within the opening, the laser beam emitted from the opening and vibrate the beam spot on the surface of the sheet metal; and a control device configured to mark a marking-off line on the surface of the sheet metal by reading, from a processing program database, a processing program for marking the marking-off line on the surface of the sheet metal and information on a vibration range of the laser beam corresponding to a set thickness of the marking-off line, and controlling the moving mechanism to move a relative position of the processing head and advance an irradiation position of the laser beam in a predetermined direction while controlling the beam vibration mechanism to vibrate the beam spot on the surface of the sheet metal at the vibration range having been read.

Further, a laser processing method according to one aspect of the present invention includes: irradiating a surface of a sheet metal with a laser beam converged, from an opening of a nozzle; and advancing an irradiation position of the laser beam emitted from the opening in a predetermined direction by moving a relative position of the nozzle with respect to the surface of the sheet metal, while swinging a trajectory of a beam spot formed on the surface of the sheet metal with a predetermined amplitude by vibrating the laser beam within the opening, to mark a marking-off line on the sheet metal.

According to the laser processing system and the laser processing method with the configurations described above, by advancing the irradiation position of the laser beam in a predetermined direction while swinging the trajectory of the beam spot formed on the surface of the sheet metal with a predetermined amplitude, it is possible to mark the sheet metal with a marking-off line that is visually recognized as having a thickness corresponding to the vibration range.

According to one aspect of the laser processing machine and the laser processing method of the present invention, it is possible to mark a wide marking-off line on the surface of the sheet metal to be laser processed without defocusing the focal point of the laser beam.

### BRIEF DESCRIPTION OF DRAWINGS

FIG. 1 is a diagram illustrating an overall configuration example of a laser processing machine of an embodiment.

FIG. 2 is a perspective view illustrating a detailed configuration example of a collimator unit and a processing head in the laser processing machine of one embodiment.

FIG. 3 is a diagram for explaining a displacement of an irradiation position of a laser beam on a sheet metal by a beam vibration mechanism.

FIG. 4 is a diagram for explaining the vibration range of the laser beam during marking of a marking-off line on the surface of the sheet metal by the laser processing machine of one embodiment.

FIG. 5 is a diagram illustrating a trajectory of a marking-off line marked on the surface of the sheet metal by the laser processing machine of one embodiment, and directions in which molten metal is blown off.

FIG. 6 is a diagram illustrating the shape of the marking-off line marked on the surface of the sheet metal by the laser processing machine of one embodiment.

FIG. 7 is a view for explaining a state in which the emission position of the laser beam from the opening of the processing head has been shifted in an advancing direction during marking of the marking-off line on the surface of the sheet metal by the laser processing machine of one embodiment.

### DESCRIPTION OF EMBODIMENT

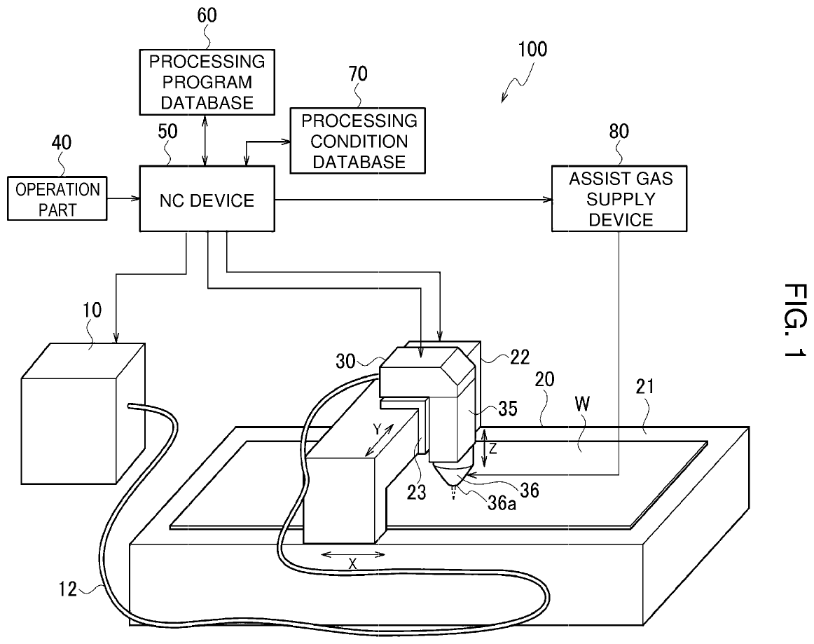

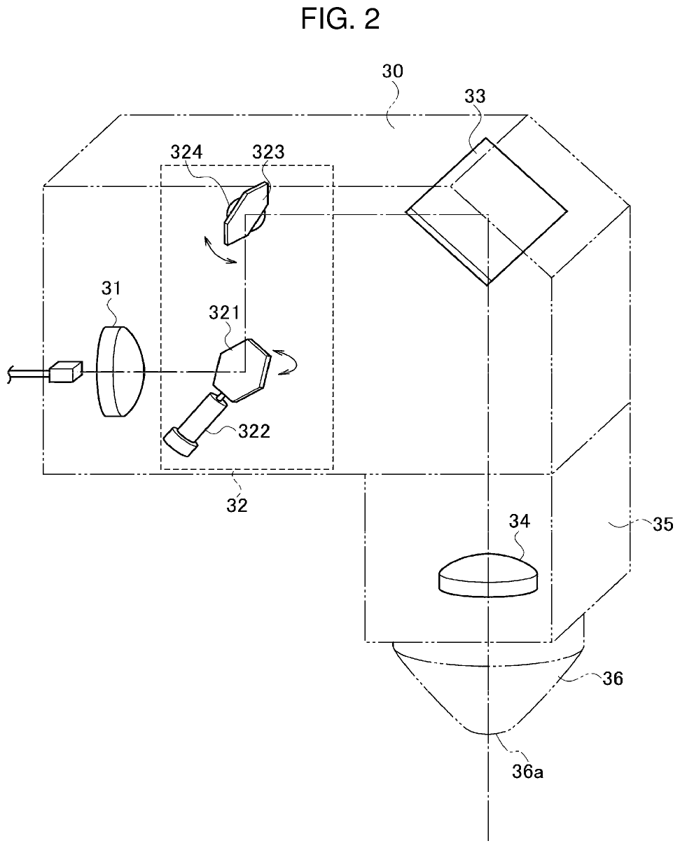

A laser processing machine and a laser processing method according to an embodiment will be described below with reference to the accompanying drawings. FIG. 1 is a diagram illustrating an overall configuration example of a laser processing machine 100 of one embodiment. FIG. 2 is a perspective view illustrating a detailed configuration example of a collimator unit 30 and a processing head 35 in the laser processing machine 100 of one embodiment. In FIG. 1, the laser processing machine 100 includes: a laser oscillator 10 that generates and emits a laser beam; a laser processing unit 20; and a process fiber 12 that transmits the laser beam emitted from the laser oscillator 10 to the laser processing unit 20. Note that the process fiber 12 may be single-core or multi-clad, and an optical coupler may be provided on a transmission path to the laser processing unit 20.

The laser processing machine 100 includes an operation part 40, a numerical control (NC) device 50, a processing program database 60, a processing condition database 70, and an assist gas supply device 80. The NC device 50 is an example of a control device that controls each part of the laser processing machine 100.

As the laser oscillator 10, a preferable one is a laser oscillator that amplifies an excitation beam emitted from a laser diode to emit a laser beam with a predetermined wavelength, or a laser oscillator that directly uses a laser beam emitted from the laser diode. The laser oscillator 10 is, for example, a solid laser oscillator, a fiber laser oscillator, a disk laser oscillator, or a direct diode laser oscillator (DDL oscillator).

The laser oscillator 10 emits a 1-μm band laser beam with a wavelength of 900 nm to 1100 nm. Taking the fiber laser oscillator and the DDL oscillator as examples, the fiber laser oscillator emits a laser beam with a wavelength of 1060 nm to 1080 nm, and the DDL oscillator emits a laser beam with a wavelength of 910 nm to 950 nm. In some cases, the laser oscillator 10 may use the wavelength band in combination with a wavelength band of a blue laser beam to a green laser beam with a wavelength of 5400 nm to 550 nm or the NIR (near infrared ray) wavelength band described above.

The laser processing unit 20 includes: a processing table 21 on which a sheet metal W to be processed is placed; the processing head 35 having a nozzle 36 that is attached to the tip end thereof and emits a laser beam from a circular opening 36a to the sheet metal W; and a gate-type X-axis carriage 22 and a gate-type Y-axis carriage 23 that move the processing head 35 to a processing position. The processing head 35 is connected to the collimator unit 30 fixed to the Y-axis carriage 23. The X-axis carriage 22 is configured to be movable in the X-axis direction on the processing table 21. The Y-axis carriage 23 is configured to be movable on the X-axis carriage 22 in the Y-axis direction perpendicular to the X-axis. The X-axis carriage 22 and the Y-axis carriage 23 function as a moving mechanism for moving the collimator unit 30 and the processing head 35 along the surface of the sheet metal W in the X-axis direction, the Y-axis direction, or an arbitrary combined direction of the X-axis and the Y-axis.

Instead of the collimator unit 30 and the processing head 35 being moved along the surface of the sheet metal W, the collimator unit 30 and the processing head 35 may be fixed in position, and the sheet metal W may move. The laser processing machine 100 may include a moving mechanism for moving the relative positions of the collimator unit 30 and the processing head 35 with respect to the surface of the sheet metal W.

The assist gas supply device 80 supplies an assist gas to the processing head 35 during the processing of the sheet metal W. When the sheet metal W to be processed is a ferrous material, the assist gas supply device 80 can use oxygen, nitrogen, or air as the assist gas. When oxygen is used as the assist gas, the assist gas supply device 80 controls the injection state of the gas to prevent excessive combustion. When the sheet metal W is a stainless-steel material, the assist gas supply device 80 can use nitrogen or air as the assist gas. The assist gas supplied to the processing head 35 is blown from the opening 36a in a direction perpendicular to the sheet metal W. The assist gas disperses molten metal within a width of kerf where the sheet metal W has melted.

The collimator unit 30 includes a collimation lens 31 that converts the laser beam being a divergent beam emitted from the process fiber 12, into a parallel beam (collimated beam). The collimator unit 30 includes a Galvano scanner unit 32, and a bend mirror 33 that reflects the laser beam emitted from the Galvano scanner unit 32 downward in the Z-axis direction perpendicular to the X-axis and the Y-axis. The processing head 35 includes a converging lens 34 that converges the laser beam reflected by the bend mirror 33 to irradiate the sheet metal W with the laser beam. Note that the laser beam being a divergent beam emitted from the process fiber 12 advances so that the center of its optical axis is located at the center of the collimation lens 31.

The laser processing machine 100 is aligned so that the laser beam emitted from the opening 36a of the nozzle 36 is positioned at the center of the opening 36a. In the reference state, the laser beam is emitted from the center of the opening 36a. The Galvano scanner unit 32 functions as a beam vibration mechanism for vibrating, within the opening 36a, the laser beam that advances in the processing head 35 and is emitted from the opening 36a. How the Galvano scanner unit 32 vibrates the laser beam will be described later.

The Galvano scanner unit 32 includes a scanning mirror 321 that reflects the laser beam emitted from the collimation lens 31, and a drive part 322 that rotates the scanning mirror 321 to have a predetermined angle. Further, the Galvano scanner unit 32 includes a scanning mirror 323 that reflects the laser beam emitted from the scanning mirror 321 and a drive part 324 that rotates the scanning mirror 323 to have a predetermined angle. The scanning mirror 321 and the scanning mirror 323 are installed to rotate in different directions.

The drive parts 322, 324 can set the scanning mirrors 321, 323 at predetermined angles, respectively, based on the control by the NC device 50. The drive parts 322, 324 are capable of reciprocally vibrating the scanning mirrors 321, 323 within a predetermined angle range. The Galvano scanner unit 32 can change the angle of one or both of the scanning mirror 321 and the scanning mirror 323 to move the beam spot of the laser beam with which the sheet metal W is irradiated. The Galvano scanner unit 32 can reciprocally vibrate one or both of the scanning mirror 321 and the scanning mirror 323 to vibrate the beam spot of the laser beam.

The Galvano scanner unit 32 is an example of the beam vibration mechanism, and the beam vibration mechanism is not limited to the Galvano scanner unit 32 including the pair of scanning mirrors.

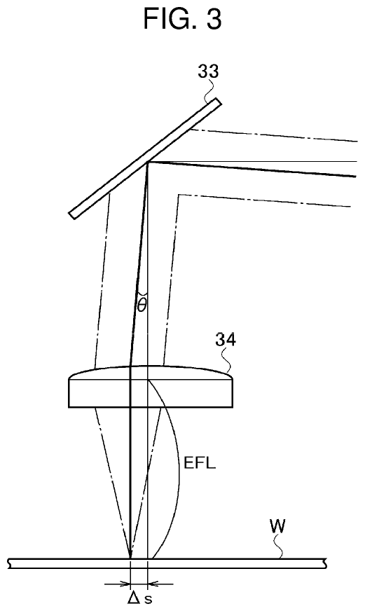

FIG. 3 is a diagram for explaining the displacement of the irradiation position of the laser beam on the sheet metal W by the Galvano scanner unit 32. Here, a state is shown where one or both of the scanning mirror 321 and the scanning mirror 323 are inclined to displace the position of the laser beam with which the sheet metal W is irradiated. In FIG. 3, the fine solid line bent by the bend mirror 33 and passing through the converging lens 34 indicates the optical axis of the laser beam, with the laser processing machine 100 in a reference state.

Specifically, due to the operation of the Galvano scanner unit 32 located in front of the bend mirror 33, the angle of the optical axis of the laser beam incident on the bend mirror 33 changes, causing the optical axis to deviate from the center of the bend mirror 33. In FIG. 3, for the sake of simplicity, the incident position of the laser beam on the bend mirror 33 is the same before and after the operation of the Galvano scanner unit 32.

It is assumed that due to the action of the Galvano scanner unit 32, the optical axis of the laser beam is displaced from the position indicated by the fine solid line to the position indicated by the thick solid line. When the laser beam reflected by the bend mirror 33 is inclined at an angle θ, the irradiation position of the laser beam on the sheet metal W is displaced by a distance Δs. When the focal distance of the converging lens 34 is an effective focal length (EFL), the distance Δs is calculated by EFL×sin θ.

When the Galvano scanner unit 32 inclines the laser beam by the angle θ in a direction opposite to the direction illustrated in FIG. 3, the irradiation position of the laser beam on the sheet metal W can be displaced by the distance Δs in a direction opposite to the direction illustrated in FIG. 3. The distance Δs is a distance less than the radius of the opening 36a, and is preferably a distance equal to or less than the maximum distance, obtained by subtracting a predetermined margin length from the radius of the opening 36a.

The NC device 50 can vibrate the laser beam in a predetermined direction on the surface of the sheet metal W by controlling the drive parts 322, 324 of the Galvano scanner unit 32. The vibration of the laser beam enables the vibration of the beam spot formed on the surface of the sheet metal W.

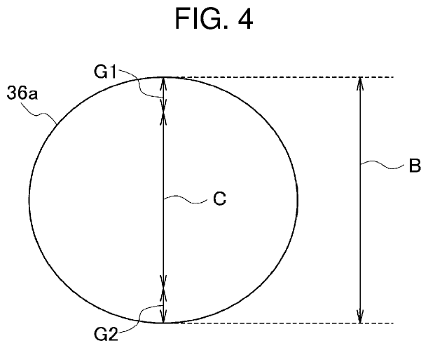

The processing program database 60 stores a processing program for marking a making-off on the surface of the sheet metal W and information on the vibration range of the laser beam corresponding to a set thickness of the marking-off line. FIG. 4 is a diagram for explaining the vibration range of the laser beam during marking of a marking-off line on the surface of the sheet metal W by the laser processing machine 100 of one embodiment. As illustrated in FIG. 4, the vibration range of the laser beam is equal to or less than the maximum distance defined by a distance C, obtained by subtracting predetermined margin lengths (G1+G2) from a diameter B of the opening 36a. The NC device 50 reads the processing program and the information on the vibration range of the laser beam from the processing program database 60. Then, the NC device 50 controls the X-axis carriage 22 and the Y-axis carriage 23 to mark the marking-off lines on the surface of the sheet metal W based on the processing program, while controlling the drive parts 322, 324 of the Galvano scanner unit 32 to vibrate the beam spot on the surface of the sheet metal W at the read vibration range.

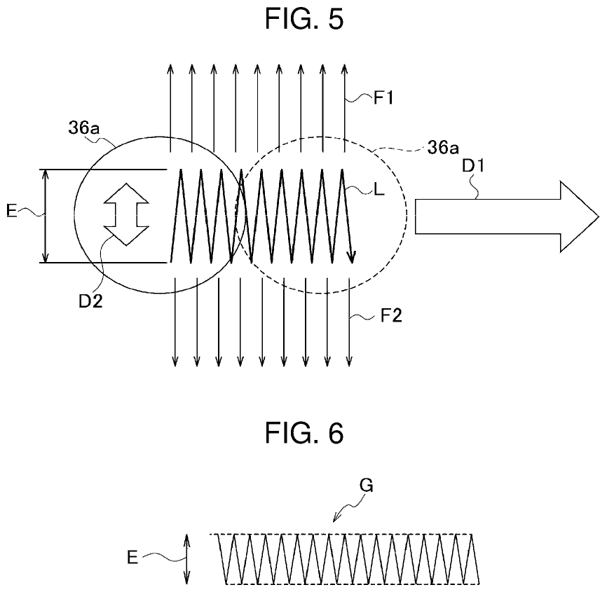

The laser processing machine 100 configured as described above marks a marking-off line on the surface of the sheet metal W, using a laser beam emitted from the laser oscillator 10. FIG. 5 is a diagram illustrating a trajectory of a marking-off line marked on the sheet metal W by the laser processing machine 100 of one embodiment, and directions in which molten metal is blown off. As illustrated in FIG. 5, the processing head 35 advances on the sheet metal W in an advancing direction D1 for drawing the marking-off line while the laser beam vibrates within the opening 36a of the nozzle 36 in a direction D2 perpendicular to the advancing direction D1 at an amplitude E/2 corresponding to the thickness of the marking-off line. In such an operation, when the position of the opening 36a of the nozzle 36 moves from the position of the opening 36a indicated by the solid line to the position of the opening 36a indicated by the dotted line, the marking-off line is marked on the sheet metal W with a trajectory as indicated by an arrow L.

During the marking process for the marking-off line, the assist gas is supplied from the assist gas supply device 80 to the processing head 35, whereby the assist gas is blown onto the sheet metal W from the opening 36a of the processing head 35. At this time, the assist gas is always blown perpendicularly onto the sheet metal W from the center position of the opening 36a. The pressure distribution of the assist gas applied to the surface of the sheet metal W changes to a low pressure by diffusion from the gap between the assist gas and the sheet metal W immediately after the assist gas is jetted out from the opening 36a. Thus, the gas pressure is highest at the center of the opening 36a, and decreases toward the periphery. In other words, the flow velocity is lowest at the center of the opening 36a, and increases toward the periphery. That is, the fluid (assist gas) velocity is highest on the edge side of the opening 36a in the vibration direction of the laser beam. Therefore, the laser beam vibrates while passing through the center position of the opening 36a, and the metal melted by the marking is blown off in directions F1, F2 which are the same as the vibration direction D2 of the laser beam, and the molten metal does not adhere to the marked marking-off line.

FIG. 6 is a diagram illustrating the shape of the marking-off line marked on the surface of the sheet metal W by the laser processing machine 100 of one embodiment. As a result of the processing described above, a distinct marking-off line can be marked on the surface of the sheet metal W, using a line G of the shape illustrated in FIG. 6, specifically a wide line G that is visually recognized as having a thickness corresponding to the amplitude E/2 of the laser beam.

The thickness of the marking-off line can be changed by appropriately changing the information on the vibration range E of the laser beam included in the processing program stored in the processing program database 60.

### Other Embodiments

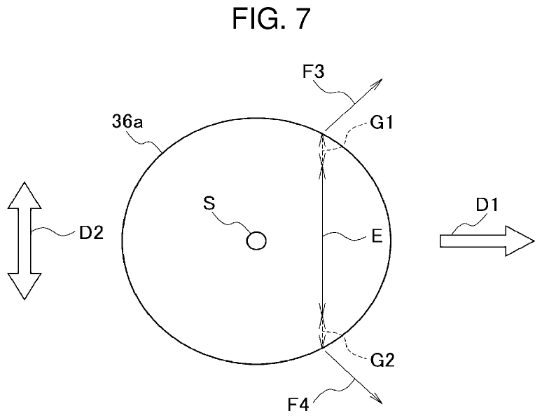

FIG. 7 is a view for explaining a state in which the emission position of the laser beam from the opening 36a of the processing head 35 has been shifted in the advancing direction during marking of the marking-off line on the surface of the sheet metal by the laser processing machine 100 of one embodiment. As illustrated in FIG. 7, the NC device 50 may control the drive parts 322, 324 of the Galvano scanner unit 32 to shift the position of emission of the laser beam from the opening 36a from the center of the opening 36a to the side of the advancing direction D1 of the laser beam and vibrate the laser beam.

By vibrating the laser beam with the emission position of the laser beam shifted as described above, the beam spot on the sheet metal W is located forward of the center S of the blowing position of the assist gas in the advancing direction D1. Therefore, the blowing direction of the molten metal is inclined toward the advancing direction D1 of the laser beam as indicated by F1 and F2, and the probability of the molten metal adhering to the marking-off line formed behind in the advancing direction D1 can be further reduced. In this case, the emission position of the laser beam can be shifted within a range in which a length (E+G1+G2) obtained by adding the predetermined margin lengths G1, G2 to the vibration range E of the laser beam fall within the opening 36a of the nozzle 36.

The present invention is not limited to the present embodiment described above, and various modifications can be made without departing from the gist of the present invention.

The disclosure of the present application relates to the subject matter described in Japanese Patent Application No. 2021-053945, filed on Mar. 26, 2021, the entire disclosure of which is incorporated herein by reference.

1. A laser processing machine comprising:
a processing head having a nozzle attached to a tip end of the machine head, the nozzle being configured to emit a laser beam from an opening;
a converging lens provided in the processing head and configured to converge the laser beam to form a beam spot on a surface of a sheet metal;
a moving mechanism configured to move a relative position of the processing head with respect to the surface of the sheet metal;
a beam vibration mechanism configured to vibrate, within the opening, the laser beam emitted from the opening and vibrate the beam spot on the surface of the sheet metal; and
a control device configured to mark a marking-off line on the sheet metal by reading, from a processing program database, a processing program for marking the marking-off line on the surface of the sheet metal and information on a vibration range of the laser beam corresponding to a set thickness of the marking-off line, and controlling the moving mechanism to move a relative position of the processing head and advance an irradiation position of the laser beam in a predetermined direction while controlling the beam vibration mechanism to vibrate the beam spot on the surface of the sheet metal at the vibration range having been read.

2. The laser processing machine according to claim 1, further comprising
an assist gas supply device configured to supply the processing head with an assist gas, the assist gas being blown onto the sheet metal from the opening during marking of a marking-off line on the sheet metal, wherein
the beam vibration mechanism vibrates the laser beam in a direction perpendicular to an advancing direction of an irradiation position of the laser beam advanced by the moving mechanism.

3. The laser processing machine according to claim 2, wherein
the beam vibration mechanism includes a function of moving the beam spot of the laser beam emitted from the opening and converged on the surface of the sheet metal, and
the control device controls the beam vibration mechanism in such a manner that a position of the beam spot on the surface of the sheet metal is located forward of a center of a blowing position of the assist gas in an advancing direction of the laser beam.

4. A laser processing method comprising
irradiating a surface of a sheet metal with a laser beam converged, from an opening of a nozzle; and
advancing an irradiation position of the laser beam emitted from the opening in a predetermined direction by moving a relative position of the nozzle with respect to the surface of the sheet metal, while vibrating a beam spot formed on the surface of the sheet metal with a predetermined amplitude by vibrating the laser beam within the opening, to mark a marking-off line on the sheet metal.
